(19) United States
(12) Patent Application Publication
(10) Pub. No.: US 2008/0110350 A1
(43) Pub. Date: May 15, 2008

(54) Electric Heating Apparatus With An Automatic Rotating Food Basket

(76) Inventor: Dong-lei Wang, Zhuhai City (CN)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 11/938,943

(22) Filed: Nov. 13, 2007

(30) Foreign Application Priority Data
Nov. 14, 2006 (CN) 200620067665.5

(51) Int. Cl. A47J 37/12

(52) U.S. Cl. 99/409

(57) ABSTRACT

The present invention provides an electric heating apparatus with an automatic rotating food basket. With the present invention, the food basket assembly is suspended inside the fryer body, and the food basket assembly is driven by the rotating mechanism to rotate 360° in the fryer body. Therefore, during the process of frying food, the food and the basket rotate together and the food is immersed fully in the hot oil, which results in even flying with less oil, and more quantity of food can be cooked.

### CROSS-REFERENCE TO RELATED APPLICATION

The present invention claims priority of CN Patent Application No. 200620067665.5 filed on Nov. 14, 2006, the contents of which are incorporated herein by reference for all purposes.

### FIELD OF THE INVENTION

The present invention relates to an electric heating apparatus, especially to an electric fryer with a rotating food basket mechanism.

### BACKGROUND OF THE INVENTION

Nowadays fryers or electric fryers sold in market normally consist of a housing, a top cover, a fryer body and a food basket, etc. During the process of heating, the basket filled with food is disposed in the fryer body, wherein the basket either stays still or swings in small angle. Because the food surfaces in basket are not evenly heated, it is likely that the food is fried uneven, that is, the food in the upper of the flyer is not cooked yet while the food at the fryer bottom is done. Therefore, less food can be put in the basket and the food should be immersed fully in the oil when the basket is put in the fryer body. Otherwise, the food above the oil surface cannot be fried properly, that is, the food which is immersed under the oil surface is cooked ready while the food above the oil surface is not cooked ready yet. During the process of flying food, the flying oil is heated up to nearly 200° C., so that users are unable to turn over the food in the fryer body to get even flying, because the hot oil may splash out to hurt people.

### SUMMARY OF THE INVENTION

The present invention is aimed at solving the problems of prior art by providing an improved electric heating apparatus with a rotating food basket mechanism so as to fry food more effectively and evenly as well as saving oil.

The electric heating apparatus with an automatic rotating food basket comprises a housing, a top cover mounted on the housing, a fryer body fixed inside said housing, a food basket assembly suspended inside said fryer body; and a rotating mechanism including a motor, a motor drive disk, a shifting fork, a rotating bracket and a basket drive shaft;

wherein said motor is fixed on a motor support mounted on one side of the fryer body; and said motor drive disk is connected to a spindle of the motor;

wherein one end of the rotating bracket near to the motor is connected with the shifting fork and the other end of the rotating bracket is connected with the basket drive shaft; and

wherein said food basket assembly is driven by said basket drive shaft of said rotating mechanism to rotate 360° in the fryer body.

The rotation of the motor drives the motor drive disk to rotate, meanwhile, the motor drive disk drives the shifting fork to rotate, in turn the shifting fork drives the rotating bracket to rotate, and then the rotating bracket drives the basket drive shaft to rotate, so as to rotate the food basket assembly.

With the present invention, the food basket assembly is suspended inside the fryer body, and the food basket assembly is driven by the rotating mechanism to rotate 360° in the fryer body. Therefore, during the process of frying food, the food and the basket rotate together and the food is immersed fully in the hot oil. As long as the oil reaches half above the food, all the food in basket can be immersed in the hot oil during the rotation of food basket assembly which results in even frying with less oil, and more quantity of food can be cooked.

The present invention has following advantages:

The basket filled with food rotates 360° in uniform speed within the fryer body by the driving force from the rotating mechanism, so that the food can be evenly immersed in the hot oil, which results in less oil, and more food can be cooked within the same cooking time.

The rotating mechanism is reasonably designed and sized.

Thanks to the effective control by a timer and a temperature controller on the rotation cycle of rotating mechanism, the food cooking time and the oil temperature, the user is able to make his own recipe in accordance with different food types and quantities, which prevents the food from being cooked rare or overcooked due to uneven frying caused by prior random manual operations. Through tests, different food can be fried in different ways to have their best taste by different recipes.

### BRIEF DESCRIPTION OF THE DRAWINGS

FIG. 1 is a side cross-sectional view of the electric heating apparatus with an automatic rotating food basket according to embodiment 1 of the present invention;

FIG. 2 is a front cross-sectional view of the electric heating apparatus as shown in FIG. 1;

FIG. 3 is an enlarged view of the rotating mechanism (Part I) of the electric heating apparatus as shown in FIG. 2;

FIG. 4 is a perspective view of the rotating food basket of the electric heating apparatus as shown in FIG. 1;

FIG. 5A is a structural view of the rotating food basket as shown in FIG. 4;

FIG. 5B is an enlarged view of Part II of the rotating food basket as shown in FIG. 5A;

FIG. 6 is a schematic view showing a remote basket lid opening and automatic basket lid closing mechanism of the rotating food basket according to embodiment 1 of the present invention;

FIG. 7A is a schematic view showing a remote basket lid opening and automatic basket lid closing mechanism of the rotating food basket according to embodiment 2 of the present invention;

FIG. 7B is a partially enlarged view of FIG. 7A along C-C line;

FIG. 8A is a schematic view showing the movement direction in the course of opening the remote basket lid opening and automatic basket lid closing mechanism as shown in FIG. 7A;

FIG. 8B is a partially enlarged view of FIG. 8A along C-C line;

FIG. 9 is a side view of the FIG. 8A;

FIG. 10A is a front view of the shifting fork of the electric heating apparatus as shown in FIG. 2;

FIG 10B is a side view of the shifting fork as shown in FIG. 10A;

FIG 11A is a right side view of the rotating bracket of the electric heating apparatus as shown in FIG. 2;

FIG. 11B is a sectional view of the rotating bracket as shown in FIG. 11A;

FIG. 11C is a left side view of the rotating bracket as shown in FIG 11B.

### DETAILED DESCRIPTION OF THE PREFERRED EMBODIMENTS

### Embodiment 1

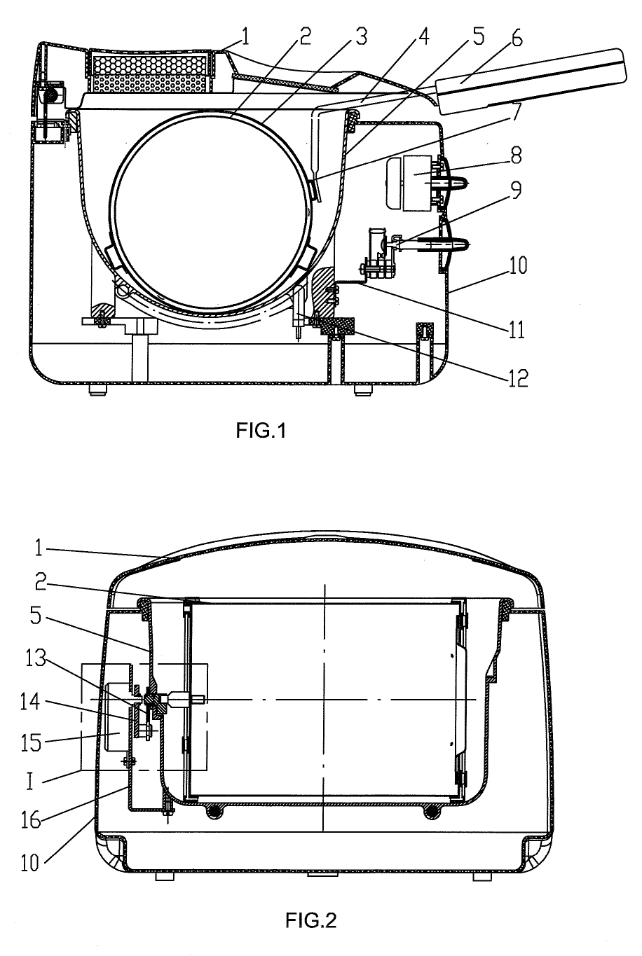

As shown in FIG. 1, the electric heating apparatus with an automatic rotating food basket comprises: a housing 10, a fryer body 5, a food basket assembly, a rotating mechanism I, and a top cover 1 mounted on the housing; wherein said fryer body 5 is fixed inside the housing 10, and the food basket assembly is suspended inside the flyer body 5.

As shown in FIG. 1, the electric heating apparatus further comprises: a timer 8, a temperature controller 9, a conductor sheet 11 and an electric heating tube 12; wherein the timer 8 is disposed on the front side of the housing 10, the temperature controller 9 is connected with the fryer body 5 by means of the conductor sheet 11, and the electric heating tube 12 is disposed at the bottom of the flyer body 5.

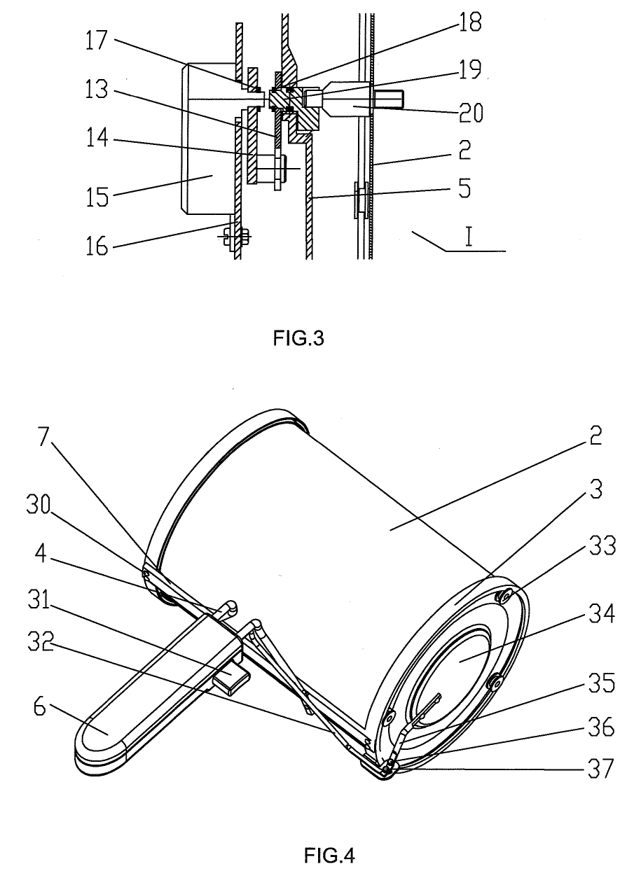

As shown in FIGS. 2 and 3, the rotating mechanism comprises: a motor 15, a motor drive disk 14, a shifting fork 13, a rotating bracket or tank 19 and a basket drive shaft 20; wherein the motor 15 is fixed on a motor support 16 and the motor support 16 is mounted on the side of the fryer body 5; the motor drive disk 14 is connected to a spindle of the motor 15 by snap springs 17; and wherein by use of snap springs 18, one end of the rotating bracket 19 near to the motor 15 is connected with the shifting fork 13 and the other end of the rotating bracket 19 is connected with the basket drive shaft 20.

As shown in FIGS. 10A and 10B, the shifting fork 13 is a flat sheet metal structure with an inverted U shape, defining a rectangular slit 132, which is opening downward, disposed on the lower part of the shifting fork 13, with a through hole 131 disposed on the upper part of the shifting fork 13; a small cylinder, protruding from the motor drive disk 14, is inserted into the slit 132 of the shifting fork 13.

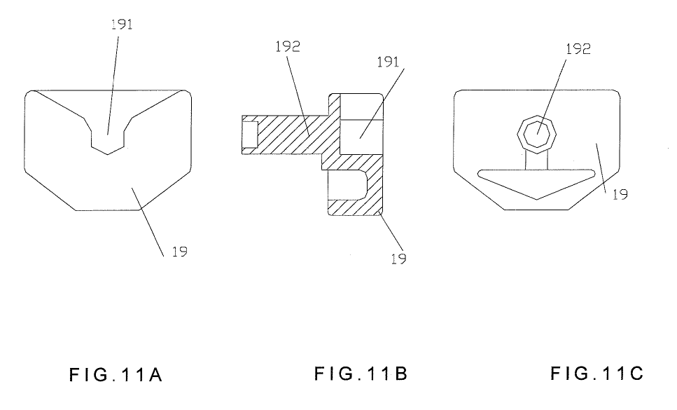

As shown in FIGS. 11A, 11B and 11C, the rotating bracket 19 is mounted on the wall of the fryer body 5 with a connecting shaft 192 extending therefrom; the connecting shaft 192 further fits within the through hole 131 of the shifting fork 13; an installation slot 191 is disposed opposite to the connecting shaft 192 on the other side of the rotating bracket 19, whereby an end of the basket drive shaft 20 is fixed or supported within the installation slot 191.

The longitudinal axes of the basket drive shaft 20, the installation slot 191 of the rotating bracket 19, and the through hole 131 of the shifting fork 13 coincide on the same line.

The rotation of the motor 15 drives the motor drive disk 14 to rotate, meanwhile, the motor drive disk 14 drives the shifting fork 13 to rotate, in turn the shifting fork 13 drives the rotating bracket 19 to rotate, and then the rotating bracket 19 drives the basket drive shaft 20 to rotate, so as to rotate the food basket assembly.

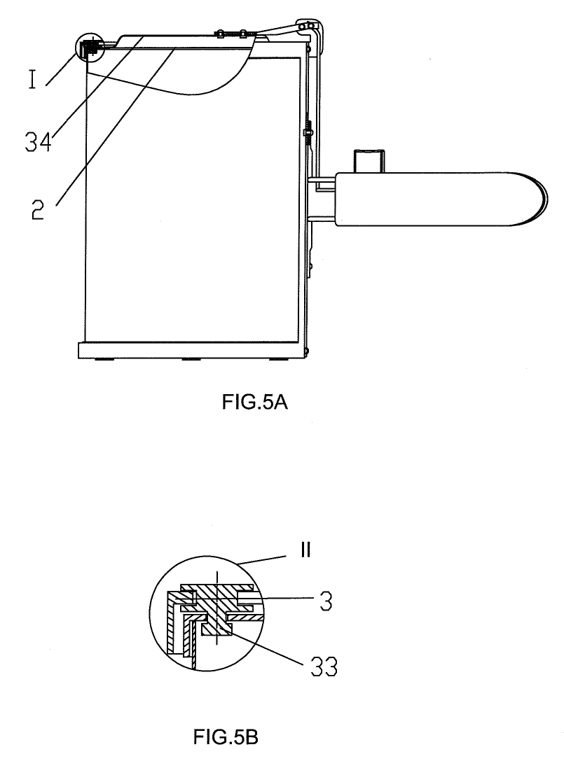

As shown in FIGS. 1, 4, 5A and 5B, the food basket assembly mainly comprises: a cylindrically shaped basket net or cage 2, left and right rings 3, each of which is disposed separately on one of the two sides of the basket net 2, a connector rod or skeleton 4, a handle 6, a fixing bar 7, rotors 33, a fixed basket lid disposed on the left side (the “left” and “right” herein are relatively designated and can be exchanged without any prejudice) of the basket net 2, and a movable basket lid 34 disposed on the right side of the basket net 2, etc. The fixing bar 7 is connected respectively with the left and right rings 3 by means of four rivets 30 so that the left and right rings 3 are tightly fastened. The fixing bar 7 is disposed in a horizontal direction, and the handle 6 extends outwardly perpendicular to the direction of the fixing bar 7. The handle 6 and the fixing bar 7 are connected by the skeleton 4, while the left and right rings 3 are used to support the whole basket assembly especially the basket net 2. The left and right rings 3 are put on fixtures, which are located at the internal bottom of the fryer body, so that the left and right rings 3 themselves do not move. Tracks are disposed on the left and right rings 3, for receiving the rotors 33, which are disposed respectively on the two transverse sides of the basket net 2, whereby the rotors 33 rotate in a circle around the left and right rings 3 along the track paths. When the rotation of the motor 15 drives the basket net 2 to rotate, the rotors 33 rotate synchronously with the basket net 2. The function of the rotors 33 is: when the basket net 2 rotates, there is a relative movement between the rotors 33 and the tracks, which enables the basket net 2 to rotate about its longitudinal axis along the peripheries of the left and right rings 3 and reduces friction, thereby the basket net 2 can rotate 360° in the fryer body 5.

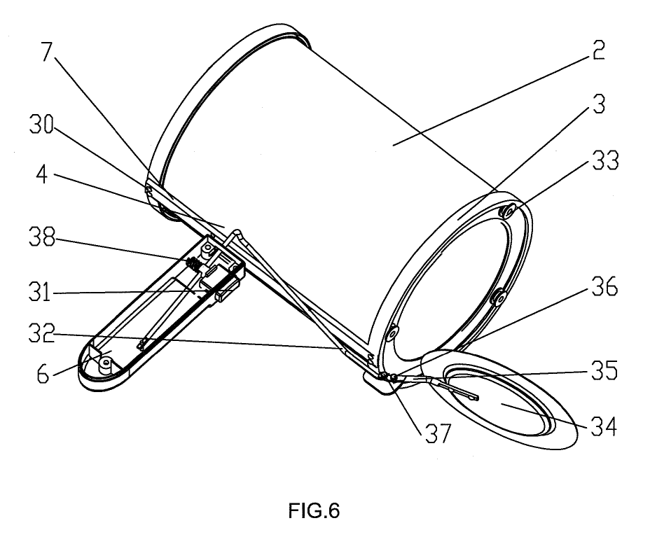

As shown in FIG. 6, an opening is disposed on the right side of the basket net 2 of the electric heating apparatus for letting food in and out, and a basket lid 34 is disposed on the opening which can be opened remotely and closed automatically. The electric heating apparatus further comprises a remote basket lid opening and automatic basket lid closing mechanism which is connected with the basket lid 34, so that the opening and closing of the basket lid 34 is controlled. As shown in FIGS. 4, 5A, 5B and 6, the remote basket lid opening and automatic basket lid closing mechanism comprises: a press button 31 and a connecting rod 32, which are respectively connected with the handle 6 and, a rocker arm 35, which is connected with the basket lid 34, pivot pins 36 and 37, and a compression spring 38. The basket lid 34 and the rocker arm 35 are riveted together. The two pivot pins 36 and 37 are disposed on one end of the rocker arm 35, and the pivot pin 36 is further connected with the right ring 3, so that the rocker arm 35 and the basket lid 34 can rotate horizontally about the pivot pin 36. The rocker arm 35 and the connecting rod 32 are connected on their ends by means of the pivot pin 37, so that the connecting rod 32 can rotate horizontally about the pivot pin 37 when the rocker arm 35 is rotating horizontally about the pivot pin 36. Because the rocker arm 35 and the connecting rod 32 are connected by the pivot pin 37, the rocker arm 35 and the connecting rod 32 can move horizontally together; the compression spring 38, which is disposed inside the handle 6 and connected with the connecting rod 32, is compressed. After pulling the whole basket assembly with food out of the fryer body 5, a user can press on the press button 31 on the side of the handle 6, then one end of the connecting rod 32 rotates about a pivot pin inside the handle 6, and the connecting rod 32 moves in the same direction as the press button 31; at this time the connecting rod 32 pulls the rocker arm 35 to rotate horizontally about the pivot pin 36, at last the basket lid 34 rotates with the rocker arm 35 and then the basket lid 34 is opened to let the food out. When releasing the press button 31, the connecting rod 32 resets under the pressure from the compression spring 38, then the basket lid 34 is closed automatically. When cooking food the basket lid 34 is closed; when the food is finished cooking, the basket assembly with food can be pulled out of the fryer body 5, then the basket lid 34 can be opened remotely and closed automatically.

### Embodiment 2

The difference between the embodiment 2 and the embodiment 1 is that the embodiment 2 employs another remote basket lid opening and automatic basket lid closing mechanism.

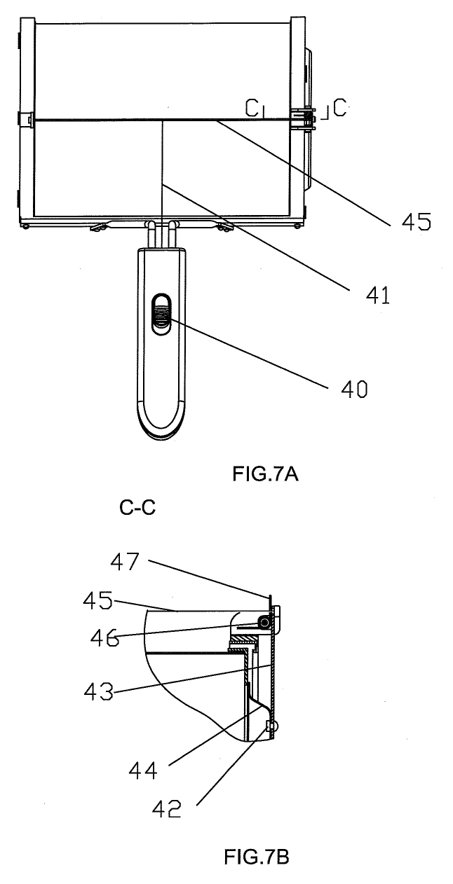

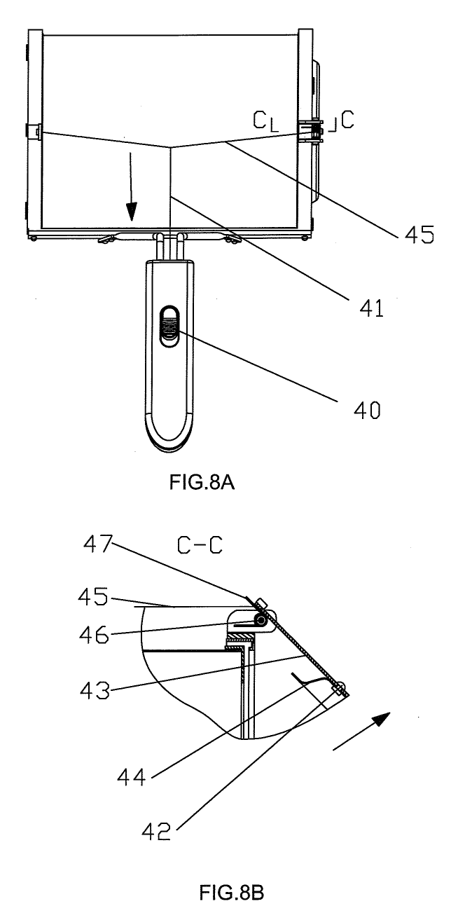

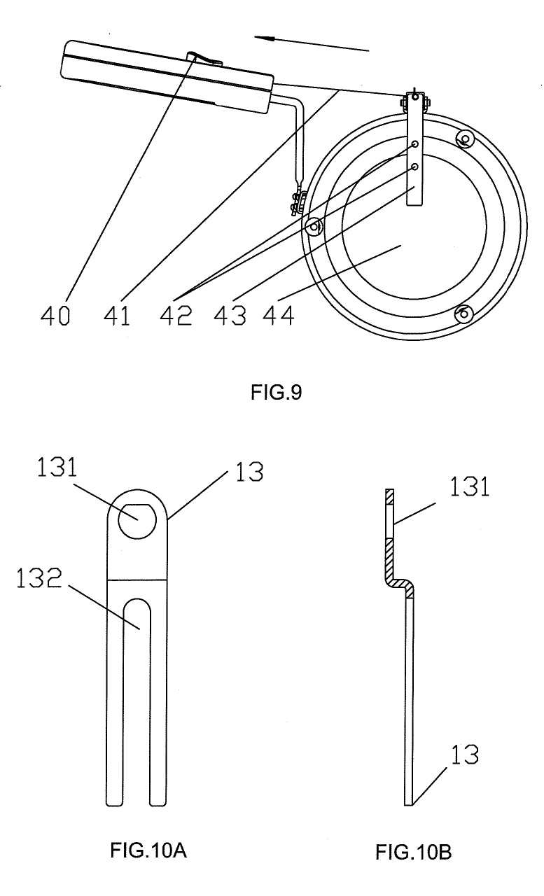

As shown in FIGS. 7A, 7B, 8A and 8B, an opening is disposed on the right side of the basket net 2 of the electric heating apparatus for letting food in and out, and a basket lid 44 is disposed on the opening which can be opened remotely and closed automatically. When cooking food the basket lid 44 is closed; when the food is finished cooking, the basket assembly with food can be pulled out of the fryer body 5, and then the basket lid 44 can be opened remotely and closed automatically. The remote basket lid opening and automatic basket lid closing mechanism comprises: a press button 40, which is disposed on the handle 6, a first pulling line 41, which is disposed in the direction of the movement of the press button 40, a rocker arm 43 with its one end connected with the basket lid 44, a second pulling line 45 by which the rocker arm 43 and the first pulling line 41 are connected, a pivot pin 46, and a torsion spring 47. The basket lid 44 and the rocker arm 43 are riveted together, and the pivot pin 46 is disposed on the other end of the rocker arm 43, so that the rocker arm 43 and the basket lid 44 can rotate about the pivot pin 46 in the upright direction. In addition, the torsion spring 47 is disposed on the pivot pin 46 so that the rocker arm 43 and the basket lid 44 are biased by the torsion spring 47 to rotate automatically about the pivot pin 46 to close the basket lid 44. One end of the second pulling line 45 is connected with the end of the rocker arm 43 near the pivot pin, the other end of the second pulling line 45 is fixed on the left ring 3 of the food basket assembly; one end of the first pulling line 41 is connected with the middle point of the second pulling line 45 and the other end of the first pulling line 41 is connected with the press button 40 of the handle 6. As shown in FIG. 9, when pushing the press button 40 backward, the first pulling line 41 moves accordingly, then the second pulling line 45 curves toward the press button 40, then the right end of the second pulling line 45 drives the rocker arm 43 and the basket lid 44 to rotate about the pivot pin 46, at last the basket lid 44 is opened to let the food out. When releasing the press button 40 to be reset, the rocker arm 43 and the basket lid 44 which are biased by the torsion spring 47, rotate automatically about the pivot pin 46 to close the basket lid 44, so that the basket lid 44 is closed remotely and/or automatically.

What is claimed:

1. An electric heating apparatus with an automatic rotating food basket comprising:
a housing;
a top cover mounted on the housing;
a fryer body fixed inside said housing;
a food basket assembly suspended inside said fryer body; and
a rotating mechanism including a motor, a motor drive disk, a shifting fork, a rotating bracket and a basket drive shaft;
wherein said motor is fixed on a motor support mounted on one side of the fryer body; and said motor drive disk is connected to a spindle of the motor;
wherein one end of the rotating bracket near to the motor is connected with the shifting fork and the other end of the rotating bracket is connected with the basket drive shaft; and
wherein said food basket assembly is driven by said basket drive shaft of said rotating mechanism to rotate 360° in the fryer body.

2. The electric heating apparatus with an automatic rotating food basket according to claim 1, wherein said shifting fork includes a slit which opens downward on a lower part of the shifting fork; and wherein a through hole is disposed on the upper part of the shifting fork; whereby a small cylinder protruding from the motor drive disk is inserted into the slit of the shifting fork.

3. The electric heating apparatus with an automatic rotating food basket according to claim 2, wherein said rotating bracket is mounted on the wall of the fryer body with a connecting shaft extending therefrom, and the connecting shaft fits within the through hole of the shifting fork; and
wherein an installation slot is disposed opposite to the connecting shaft on the other side of the rotating bracket, whereby an end of the basket drive shaft is supported within said installation slot.

4. The electric heating apparatus with an automatic rotating food basket according to claim 3, wherein longitudinal axes of the basket drive shaft, the installation slot of the rotating bracket, and the through hole of the shifting fork coincide on the same line.

5. The electric heating apparatus with an automatic rotating food basket according to claim 1, wherein the electric heating apparatus further comprises: a timer, a temperature controller, a conductor sheet, and an electric heating tube; wherein the timer is disposed on the front side of the housing, the temperature controller is connected with the fryer body by means of the conductor sheet, and the electric heating tube is disposed at the bottom of the fryer body.

6. The electric heating apparatus with an automatic rotating food basket according to claim 1, wherein said food basket assembly comprises: a cylindrical basket net, left and right rings, each of which is disposed separately on one of the two sides of the basket net, a skeleton, a handle, a fixing bar, rotors, a fixed basket lid disposed on the left side of the basket net, and a movable basket lid disposed on the right side of the basket net.

7. The electric heating apparatus with an automatic rotating food basket according to claim 6, wherein
said fixing bar is connected respectively with the left and right rings so that the left and right rings are tightly fastened;
said fixing bar is disposed in a horizontal direction, and the handle extends outwardly perpendicular to the direction of the fixing bar; the handle and the fixing bar are connected by the skeleton, said left and right rings are put on fixtures which are located at the internal bottom of the fryer body.

8. The electric heating apparatus with an automatic rotating food basket according to claim 7, wherein
an opening is disposed on the right side of the basket net of the electric heating apparatus for letting food in and out, and a basket lid is disposed on the opening which can be opened remotely and closed automatically;
said electric heating apparatus further comprises a remote basket lid opening mechanism which is connected with the basket lid;
said remote basket lid opening mechanism comprises: a press button and a connecting rod, which are respectively connected with the handle, a rocker arm, which is connected with the basket lid, pivot pins, and a compression spring;
said basket lid and the rocker arm are connected together, two pivot pins are disposed on one end of the rocker arm, and one of the pivot pins is further connected with the right ring; the rocker arm and the connecting rod are connected on their ends by means of the other pivot pin; the compression spring, which is disposed inside the handle and connected with the connecting rod, is compressed.

9. The electric heating apparatus with an automatic rotating food basket according to claim 7, wherein
an opening is disposed on the right side of the basket net of the electric heating apparatus for letting food in and out, and a basket lid is disposed on the opening which can be opened remotely and closed automatically;
said electric heating apparatus further comprises a remote basket lid opening mechanism which is connected with the basket lid;
said remote basket lid opening mechanism comprises: a press button which is disposed on the handle, a first pulling line which is disposed in the direction of the movement of the press button, a rocker arm with its one end connected with the basket lid, a second pulling line by which the rocker arm and the first pulling line are connected, a pivot pin, and a torsion spring;
said basket lid and the rocker arm are connected together, the pivot pin is disposed on the other end of the rocker arm; the torsion spring is disposed on the pivot pin;
one end of said second pulling line is connected with one end of the rocker arm, the other end of the second pulling line is fixed on the left ring of the food basket assembly;
one end of the first pulling line is connected with the middle point of the second pulling line and the other end of the first pulling line is connected with the press button of the handle.

10. The electric heating apparatus with an automatic rotating food basket according to claim 2, wherein said food basket assembly comprises: a cylindrical basket net, left and right rings, each of which is disposed separately on one of the two sides of the basket net, a skeleton, a handle, a fixing bar, rotors, a fixed basket lid disposed on the left side of the basket net, and a movable basket lid disposed on the right side of the basket net.

11. The electric heating apparatus with an automatic rotating food basket according to claim 10, wherein
said fixing bar is connected respectively with the left and right rings so that the left and right rings are tightly fastened;
said fixing bar is disposed in a horizontal direction, and the handle extends outwardly perpendicular to the direction of the fixing bar; the handle and the fixing bar are connected by the skeleton, said left and right rings are put on fixtures which are located at the internal bottom of the fryer body.

12. The electric heating apparatus with an automatic rotating food basket according to claim 11, wherein
an opening is disposed on the right side of the basket net of the electric heating apparatus for letting food in and out, and a basket lid is disposed on the opening which can be opened remotely and closed automatically;
said electric heating apparatus further comprises a remote basket lid opening mechanism which is connected with the basket lid;
said remote basket lid opening mechanism comprises: a press button and a connecting rod, which are respectively connected with the handle, a rocker arm, which is connected with the basket lid, pivot pins, and a compression spring;
said basket lid and the rocker arm are connected together, two pivot pins are disposed on one end of the rocker arm, and one of the pivot pins is further connected with the right ring; the rocker arm and the connecting rod are connected on their ends by means of the other pivot pin; the compression spring, which is disposed inside the handle and connected with the connecting rod, is compressed.

13. The electric heating apparatus with an automatic rotating food basket according to claim 11, wherein
an opening is disposed on the right side of the basket net of the electric heating apparatus for letting food in and out, and a basket lid is disposed on the opening which can be opened remotely and closed automatically;
said electric heating apparatus further comprises a remote basket lid opening mechanism which is connected with the basket lid;
said remote basket lid opening mechanism comprises: a press button which is disposed on the handle, a first pulling line which is disposed in the direction of the movement of the press button, a rocker arm with its one end connected with the basket lid, a second pulling line by which the rocker arm and the first pulling line are connected, a pivot pin, and a torsion spring;
said basket lid and the rocker arm are connected together, the pivot pin is disposed on the other end of the rocker arm; the torsion spring is disposed on the pivot pin;
one end of said second pulling line is connected with one end of the rocker arm, the other end of the second pulling line is fixed on the left ring of the food basket assembly; one end of the first pulling line is connected with the middle point of the second pulling line and the other end of the first pulling line is connected with the press button of the handle.

14. The electric heating apparatus with an automatic rotating food basket according to claim 3, wherein said food basket assembly comprises: a cylindrical basket net, left and right rings, each of which is disposed separately on one of the two sides of the basket net, a skeleton, a handle, a fixing bar, rotors, a fixed basket lid disposed on the left side of the basket net, and a movable basket lid disposed on the right side of the basket net.

15. The electric heating apparatus with an automatic rotating food basket according to claim 4, wherein said food basket assembly comprises: a cylindrical basket net, left and right rings, each of which is disposed separately on one of the two sides of the basket net, a skeleton, a handle, a fixing bar, rotors, a fixed basket lid disposed on the left side of the basket net, and a movable basket lid disposed on the right side of the basket net.

16. The electric heating apparatus with an automatic rotating food basket according to claim 5, wherein said food basket assembly comprises: a cylindrical basket net, left and right rings, each of which is disposed separately on one of the two sides of the basket net, a skeleton, a handle, a fixing bar, rotors, a fixed basket lid disposed on the left side of the basket net, and a movable basket lid disposed on the right side of the basket net.

17. The electric heating apparatus with an automatic rotating food basket according to claim 16, wherein
said fixing bar is connected respectively with the left and right rings so that the left and right rings are tightly fastened;
said fixing bar is disposed in a horizontal direction, and the handle extends outwardly perpendicular to the direction of the fixing bar; the handle and the fixing bar are connected by the skeleton, said left and right rings are put on fixtures which are located at the internal bottom of the flyer body.

18. The electric heating apparatus with an automatic rotating food basket according to claim 17, wherein
an opening is disposed on the right side of the basket net of the electric heating apparatus for letting food in and out, and a basket lid is disposed on the opening which can be opened remotely and closed automatically;
said electric heating apparatus further comprises a remote basket lid opening mechanism which is connected with the basket lid;
said remote basket lid opening mechanism comprises: a press button and a connecting rod, which are respectively connected with the handle, a rocker arm, which is connected with the basket lid, pivot pins, and a compression spring;
said basket lid and the rocker arm are connected together, two pivot pins are disposed on one end of the rocker arm, and one of the pivot pins is further connected with the right ring; the rocker arm and the connecting rod are connected on their ends by means of the other pivot pin; the compression spring, which is disposed inside the handle and connected with the connecting rod, is compressed.

19. The electric heating apparatus with an automatic rotating food basket according to claim 17, wherein
an opening is disposed on the right side of the basket net of the electric heating apparatus for letting food in and out, and a basket lid is disposed on the opening which can be opened remotely and closed automatically;
said electric heating apparatus further comprises a remote basket lid opening mechanism which is connected with the basket lid;
said remote basket lid opening mechanism comprises: a press button which is disposed on the handle, a first pulling line which is disposed in the direction of the movement of the press button, a rocker arm with its one end connected with the basket lid, a second pulling line by which the rocker arm and the first pulling line are connected, a pivot pin, and a torsion spring;
said basket lid and the rocker arm are connected together, the pivot pin is disposed on the other end of the rocker arm; the torsion spring is disposed on the pivot pin;
one end of said second pulling line is connected with one end of the rocker arm, the other end of the second pulling line is fixed on the left ring of the food basket assembly; one end of the first pulling line is connected with the middle point of the second pulling line and the other end of the first pulling line is connected with the press button of the handle.
